(19) United States
(12) Patent Application Publication
(10) Pub. No.: US 2022/0234546 A1
(43) Pub. Date: Jul. 28, 2022

(54) SENSOR VISIBILITY SYSTEM

(71) Applicant: DEKA Products Limited Partnership, Manchester, NH (US)

(72) Inventors: Christopher C. LANGENFELD, Nashua, NH (US); Michael J. SLATE, Merrimack, NH (US); John C. LANGENFELD, Nashua, NH (US); Justin M. WHITNEY, Goffstown, NH (US); Spencer TRAFTON, Nashua, NH (US)

(21) Appl. No.: 17/648,861

(22) Filed: Jan. 25, 2022

Related U.S. Application Data
(60) Provisional application No. 63/141,009, filed on Jan. 25, 2021.

(51) Int. Cl. B60S 1/56; B60S 1/08; B60S 1/18; B08B 1/00; B08B 1/02

(52) U.S. Cl. CPC B60S 1/56; B60S 1/08; B08B 1/02; B08B 1/005; B60S 1/18

(57) ABSTRACT

The system of the present teachings for maintaining an unobstructed pathway through which sensors can capture data. The system includes at least one stationary wiper assembly, at least one movable shield assembly housing the sensors, and at least one barrier assembly protecting the interior of the stationary assembly and the movable shield assembly from environmental contaminants.

### CROSS REFERENCE TO RELATED APPLICATIONS

This utility patent application claims the benefit of U.S. Provisional Patent Application Ser. No. 63/141,009 filed Jan. 25, 2021, entitled Sensor Visibility System (Attorney Docket No. AA435), which is incorporated herein by reference in its entirety.

### BACKGROUND

Sensors that are exposed to environmental conditions such as, for example, but not limited to rain, snow, ice, mud, vector droppings, and other foreign bodies can become obstructed and thus can perform less optimally. If the sensors are mounted on moving vehicles, the environmental conditions can impair the ability of the sensor to visualize obstacles. Such an impairment can pose a hazard for other vehicles and users of the road or sidewalk. Windshield wipers that move side to side are in customary use to remove foreign objects. Not only are wiper blades subject to wear that can cause incomplete clearing of the windshield, conventional moving wipers generally require a relatively lateral surface to travel upon. A further deficiency of wiper blades that are commonly used is that they do not scale well, especially on the smaller scale.

What is needed is a system that can maintain an unobstructed pathway for a sensor to capture data.

### SUMMARY

The system of the present teachings for maintaining an unobstructed pathway through which sensors can capture data can include, but is not limited to including, at least one stationary wiper assembly, at least one movable shield assembly housing the sensors, and at least one barrier assembly protecting the interior of the stationary assembly and the movable shield assembly from environmental contaminants. In particular, the system of the present teachings can provide for debris removal from the movable shield assembly.

The system of the present teachings for maintaining an unobstructed pathway, the unobstructed pathway enabling at least one sensor to capture sensor data, can include, but is not limited to including, at least one movable component protecting the at least one sensor, and at least one stationary component. The at least one stationary component can include, but is not limited to including, at least one at least one wiper blade assembly, at least one sensor, at least one mounting surface for the at least one sensor, and a means to move the at least one moveable component. The at least one stationary component can wipe the at least one movable component as the at least one movable component moves past the at least one wiper blade. The at least one wiper blade assembly can optionally include at least one wiper blade holder integrated with at least one wiper blade. The at least one wiper blade assembly can optionally include at least one wiper blade holder including at least one wiper blade cartridge cavity, and at least one wiper blade cartridge removably positioned within the at least one wiper blade cartridge cavity. The at least one wiper blade assembly can optionally include at least one wiper blade, and at least one spring operably coupled with the at least one wiper blade. The at least one spring can enable compliant motion of the at least one wiper blade with respect to the at least one moveable component. The at least one movement component can optionally include at least one motor gear. The at least one stationary component can optionally include at least one movement component moving the at least one movable component, and at least one barrier between the at least one sensor and an environment surrounding the at least one sensor. The at least one barrier can optionally include at least one an environmental seal, at least one housing, at least one platform, and at least one platform clamp clamping the at least one platform and the at least one housing around the at least one environmental seal. The clamping can prevent environmental contaminants from entering an interior of the at least one movement component and the at least one stationary component. The at least one platform clamp can optionally include at least one v-clamp. The at least one movable component can optionally include at least one shield situated in a field of view of the at least one sensor, and at least one movement component interface operably coupled with the at least one movement component. The at least one movement component and the at least one movement component interface can enable movement of the at least one moveable component. The at least one shield can optionally include at least one dome surrounding the at least one sensor. The at least one dome can optionally include a circular shape. The at least one movement component interface can optionally include a ring gear.

### BRIEF DESCRIPTION OF THE DRAWINGS

The present teachings will be more readily understood by reference to the following description, taken with the accompanying drawings, in which:

FIG. 1 is a pictorial representation of a first configuration of the present teachings for maintaining a clear surface through which sensors can collect data;

FIG. 2 is a pictorial representation of a second configuration of the present teachings for maintaining a clear surface through which sensors can collect data;

FIG. 3 is a pictorial representation of a vehicle including an implementation of the first configuration of the present teachings mounted atop;

FIG. 4 is a perspective diagram of a cargo box having an implementation of the first configuration the present teachings mounted atop;

FIG. 5A is a perspective diagram of an implementation of the first configuration of the system of the present teachings;

FIG. 5B is a exploded perspective diagram of an implementation of the first configuration of the major components of the system of the present teachings including at least one sensor;

FIG. 5C is a exploded perspective diagram of an implementation of the first configuration of the major components of the sensor vision issue mitigation device of the present teachings;

FIG. 5D is a perspective diagram of an implementation of the first configuration of the system of the present teachings without the rotatable shield, seen from various perspectives;

FIG. 6 is a schematic exploded perspective diagram of rotatable and stationary components of the present teachings;

FIGS. 7A, 7B, and 7C are cross section perspective diagrams of an implementation of the first configuration of the system of the present teachings;

FIG. 7D is an exploded cross section perspective diagram of an implementation of the first configuration of the system of the present teachings;

FIG. 8A shows various views of perspective diagrams of an implementation of the first configuration of the wiper blade holder of the present teachings;

FIG. 8B shows various views of perspective diagrams of an implementation of the first configuration of the wiper blade cartridge and wiper blade holder of the present teachings;

FIG. 8C shows various views of perspective diagrams of an implementation of the first configuration of the clamp of the present teachings;

FIG. 8D shows various views of perspective diagrams of an implementation of the first configuration of the interface flange of the present teachings;

FIG. 8E shows various views of perspective diagrams of an implementation of the first configuration of the output flange of the present teachings;

FIG. 8F shows various views of perspective diagrams of an implementation of the first configuration of the housing of the present teachings;

FIG. 8G shows various views of perspective diagrams of an implementation of the first configuration of the ring gear of the present teachings;

FIG. 8H shows various views of perspective diagrams of an implementation of the first configuration of the sensor platform of the present teachings;

FIG. 8I shows various views of perspective diagrams of an implementation of the first configuration of the stationary platform of the present teachings;

FIG. 8J shows various views of perspective diagrams of an implementation of the first configuration of the motor of the present teachings;

FIG. 8K shows various views of perspective diagrams of an implementation of the first configuration of the motor gear of the present teachings;

FIGS. 9A-9B are perspective diagrams of an implementation of a second configuration of the system of the present teachings;

FIG. 10 is a exploded perspective diagram of the configuration of FIGS. 9A-9B of the major components of the system of the present teachings including at least one sensor;

FIG. 11 is an exploded perspective diagram of parts of an implementation of the second configuration of the system of the present teachings;

FIG. 12 is a cross section diagram of an implementation of the second configuration of FIGS. 9A-9B; and

FIG. 13 is a top view of an implementation of the second configuration of the present teachings.

### DETAILED DESCRIPTION

The system of the present teachings for maintaining an unobstructed pathway through which sensors can capture data can include, but is not limited to including, a shield assembly for protecting the sensors, a stationary wiper for clearing the shield, and a barrier between the sensors and the environment.

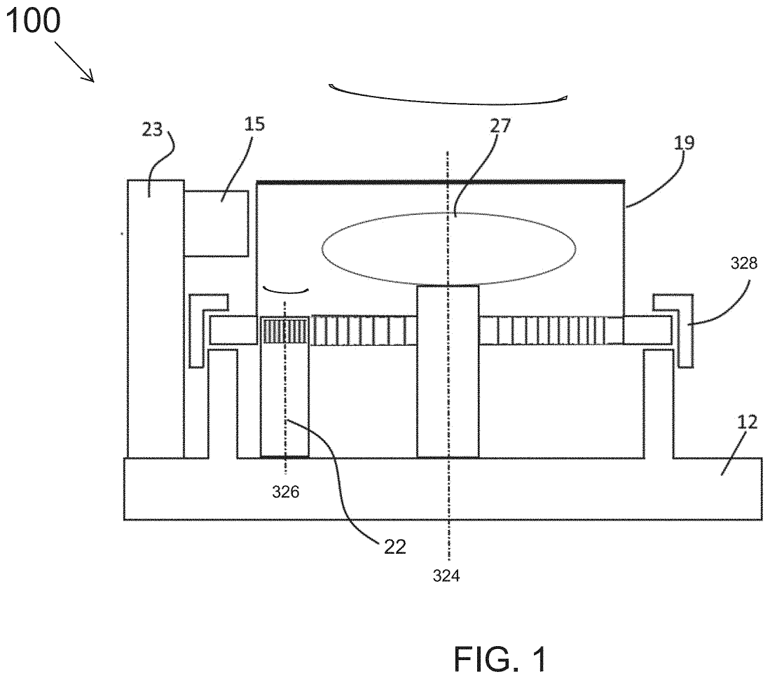

Referring now to FIG. 1, first configuration system 100 can include, but is not limited to including, a movable component, a stationary component that moves the movable component and cleans the transparent movable component, and an environmental barrier or seal between the movable and the stationary components. The stationary component includes sensors, a stationary movement means, a wiper configuration, and the environmental barrier. The movable component includes a shield configuration and a moveable movement means. With respect to the stationary component, in some configurations, the wiper configuration includes, for example, wiper blade holder 23 and wiper blade 15. In some configurations, wiper blade holder 23 and wiper blade 15 can be separate parts. In some configurations, wiper blade holder 23 and wiper blade 15 can be formed into a single component. In some configurations, the movement means includes motor 22. Other movement options are possible. In some configurations, sensor(s) 27, environmental barrier 328, wiper configuration and movement means are mounted to a platform, for example, mounting platform 12. In some configurations, there can be multiple mounting platforms, or other means to stabilize the components. Environmental barrier 328 protects the interior of the system from environmental contaminants such as water and debris.

Continuing to still further refer to FIG. 1, with respect to the moveable component, in some configurations, the shield configuration includes shield 19 that protects sensor(s) 27 from visual impairment as shield 19 is moved and cleared of obstructions by wiper 15. Shield 19 is positioned to surround sensor(s) 27 to protect the fields of view of sensor(s) 27, and is transparent to the electromagnetic spectrum associated with sensor(s) 27. For example, if sensor(s) 27 include camera and devices, shield 19 would at least be transparent in the visual spectrum. The shield configuration includes lid 17 that is weather-sealed to shield 19, and protects sensor(s) 27 from environmental hazards. In some configurations, sensor(s) 27 gather data over a pre-selected field of view, for example, but not limited to, a 360° view. In some configurations, shield 19 encircles sensor(s) 27. No matter the configuration of sensor(s) 27, the wiper configuration, sensor(s) 27, and environmental barrier 328 remain stationary with respect to the underlying platform upon which sensor(s) 27 are mounted while shield 19 moves, for example, but not limited to, laterally, vertically, and/or rotationally. In a rotational configuration, as shield 19 rotates around axis 324, wiper blade holder 23 retains wiper blade 15 in a stationary position with respect to the moving shield configurations. Wiper 15 is positioned to be in contact with the exterior of shield 19 so that, as shield 19 rotates, wiper blade 15 clears any obstructions from shield 19, leaving sensor(s) 27 free to collect data without being impaired by obstructions. In some configurations, the movable movement mechanism includes a gear that is driven by motor 22. Other movable movement mechanisms are possible. In some configurations, shield 19 includes a circular shape that completely or partially surrounds sensor(s) 27. Shield 19 is rotated in various ways including, but not limited to, a ring gear that is operably coupled with, and rotates with, shield 19. Motor 22 rotates a motor gear around axis 326. The motor gear drives the ring gear. Environmental barrier 328 seals sensors 27 from environmental debris as shield 19 rotates.

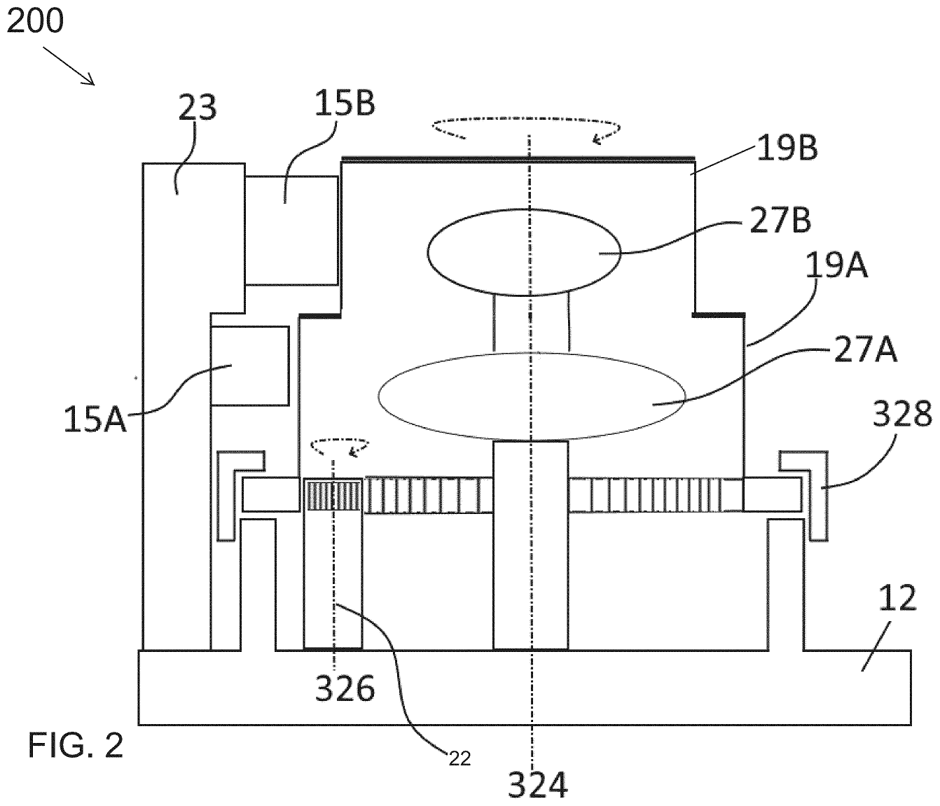

Referring now to FIG. 2, second configuration system 200 includes multiple sensors and multiple shield configurations. For example, sensor(s) 27A are surrounded by rotating shield 19A, and sensor(s) 27B are surrounded by rotating shield 19B. Each rotating configuration is accompanied by stationary wiper 15A/15B. In some configurations, environmental seal 328, motor 22, and the ring gear drive and protect both shields 19A/19B. In some configurations, multiple ring gears, multiple motors, and multiple environmental seals drive and protect shields 19A/19B separately. The present teachings are not limited to two sets of sensors 27A/27B. The present teachings are not limited to stacked sensors, but can also include side-by-side sensors protected by a single shield configuration, or separate shield configurations.

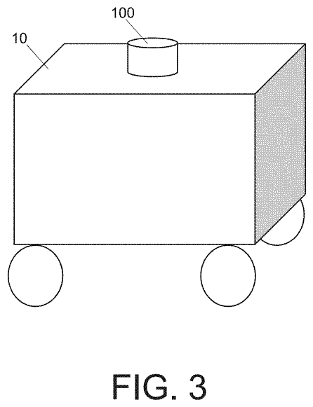

Referring now to FIG. 3, an exemplary first configuration system 100 of the present teachings for maintaining sensor visions can be mounted upon exemplary vehicle 10, wherever sensors are located. For example, when sensors are mounted atop and/or beneath a vehicle, first configuration system 100 can surround the sensors to maintain a 360° field of view free from obstructions. Common obstructions for top-mounted sensors can include precipitation, insects, bird excrement, and road/sidewalk dirt. Common obstructions for bottom-mounted sensors can include mud, dirt, road salt, road debris, and snow plow debris. When sensors are mounted to the front, sides, and/or rear of a vehicle, other configurations of system 100 can be mounted in front of the sensors to maintain a view for the sensors that is free from obstructions. Common obstructions for front-mounted sensors can include road debris, precipitation, and insects. Common obstructions for side-mounted sensors can include road/sidewalk splashing and precipitation. Common obstructions for rear-mounted sensors can include road splashings and mud. The systems of the present teachings can enable vehicle 10 to autonomously navigate during sub-optimal environmental situations.

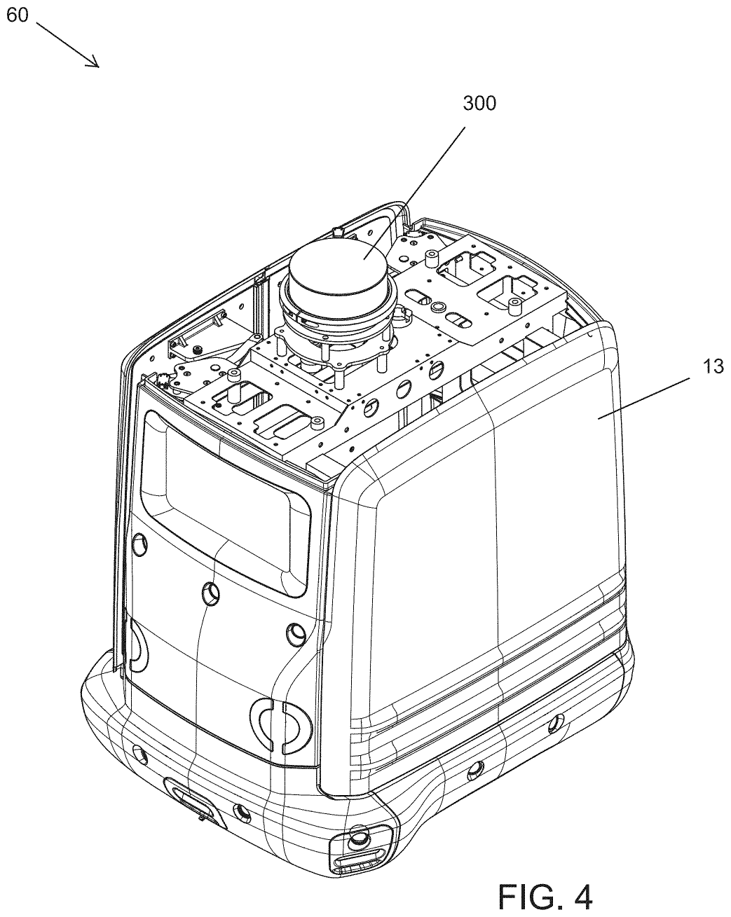

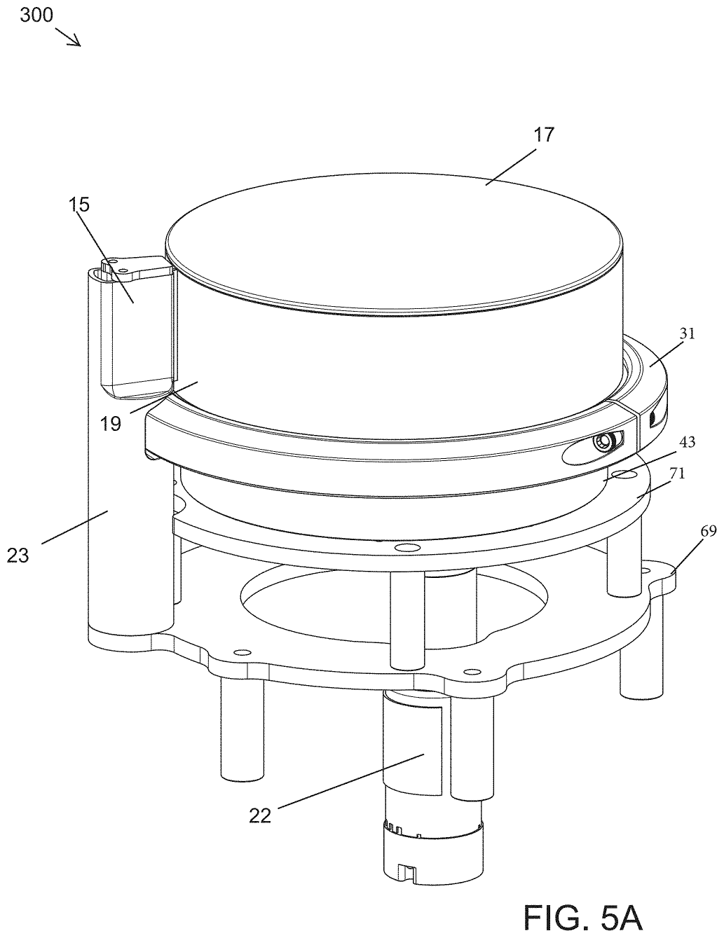

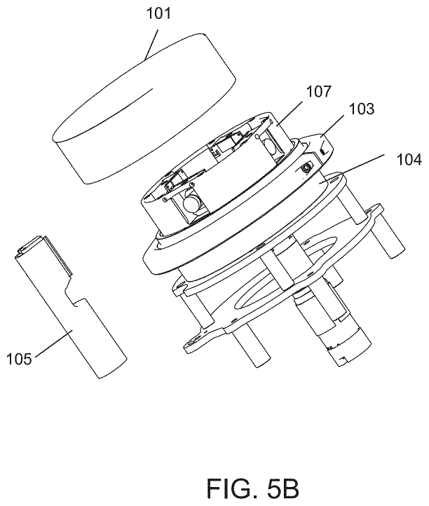

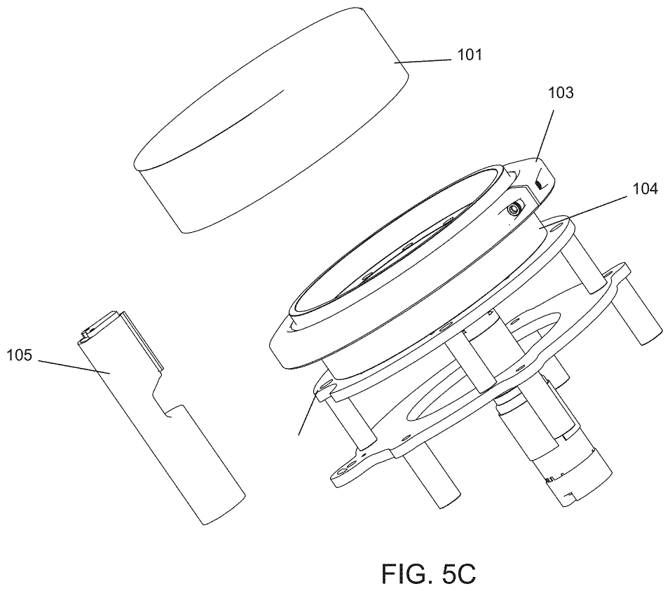

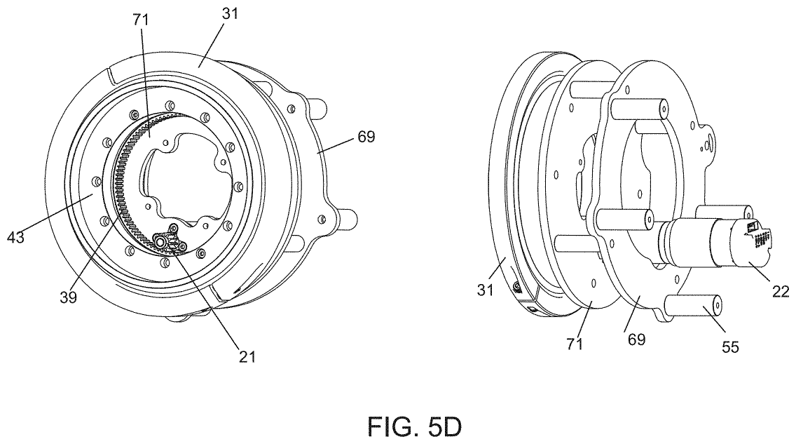

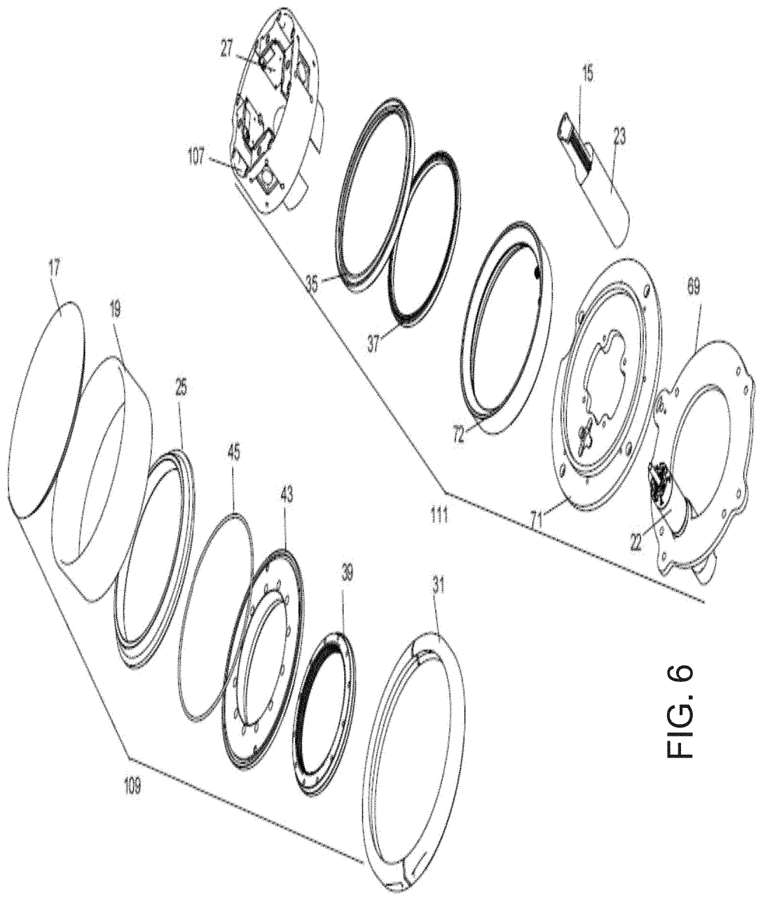

Referring now to FIGS. 4, 5A-5D and 6, exemplary vehicle cargo box 60 can include exemplary system 300 mounted upon cargo chassis 13. Exemplary system 300 can include rotatable assembly 109 (FIG. 6) and stationary assembly 111 (FIG. 6). Rotatable assembly 109 (FIG. 6) includes components of exemplary system 300 that rotate during operation of exemplary system 300. Stationary assembly 111 (FIG. 6) includes components of exemplary system 300 that remain stationary during operation of exemplary system 300 while enabling environmental isolation and smooth movement of rotation assembly 109 (FIG. 6). Exemplary system 300 can include assemblies such as dome assembly 101 (FIG. 5B), sensor assembly 107 (FIG. 5B), rotation support assembly 103 (FIG. 5B), environmental barrier assembly 104 (FIG. 5B), and wiper assembly 105 (FIG. 5B). Dome assembly 101 (FIG. 5B) and rotation support assembly 103 (FIG. 5B) rotate, while sensor assembly 107 (FIG. 5B), environmental barrier assembly 104 (FIG. 5B), and wiper assembly 105 (FIG. 5B) provide support to the rotating components and remain themselves stationary. In some configurations, rotatable assembly 109 (FIG. 6) can rotate at about 60rpm, but can rotate at any desired speed to wipe water, snow, sleet, and debris, for example, from dome assembly 101 (FIG. 5C).

Continuing to refer to FIGS. 5A-5D and 6, dome assembly 101 (FIG. 5B), including, but not limited to, shield 19 (FIG. 5A) and lid 17 (FIG. 5A), joins with rotation support assembly 103 (FIG. 5B), including, but not limited to, clamp 31 (FIG. 5A) and output flange 43 (FIG. 5A), to rotate dome assembly 101 (FIG. 5B) and protect sensors 107 (FIG. 5B). While dome assembly 101 (FIG. 5B) is rotating, wiper configuration 105 (FIG. 5B), including, but not limited to, wiper blade 15 (FIG. 5A), is held in contact with dome assembly 101 (FIG. 5B) by wiper blade holder 23 (FIG. 5B), and remains stationary while dome assembly 101 (FIG. 5B) rotates. In some configurations, rotation support assembly 103 (FIG. 5B) can include ring gear 39 (FIG. 5D), output flange 43 (FIG. 5D), o-ring 45 (FIG. 6), interface flange 25 (FIG. 6), and clamp 31 (FIG. 6). Dome assembly 101 (FIG. 5C) can be bonded to interface flange 25 (FIG. 6), which is operably coupled with output flange 43 (FIG. 6), also referred to as rotating base ring 43. In some configurations, clamp 31 (FIG. 6) secures the coupling between interface flange 25 (FIG. 6) and output flange 43 (FIG. 6), and o-ring 45 (FIG. 6) weather-seals the coupling. Other environmental sealing configurations are possible. The secure coupling enables rotatable assembly 109 (FIG. 6) to rotate dome assembly 101 (FIG. 5C) around sensor assembly 107 (FIG. 5C). In some configurations, the system of the present teachings can include a device that can move fluid from a reservoir, through hoses, into nozzles, and to the outer surface of shield 19. The fluid can moisturize shield 19 so that wiper blade 15 can more easily remove the debris on shield 19. In some configurations, shield 19 can move a pre-selected distance and remain stationary for a pre-selected amount of time. In some configurations, shield 19 can oscillate back and forth without making a complete traversal along an entire possible pathway. In some configurations, shield 19 can oscillate in front of a sensor's field of view. In some configurations, for example in configurations where sensor 27 can alert a controller that a visual obstruction has been detected on shield 19, shield 19 can be fixedly or temporarily situated beyond the obstruction, providing a clear view for sensor 27. Repositioning shield 19 can occur continually if necessary. The obstruction can be removed manually if necessary, while sensor 27 retains a clear field of view.

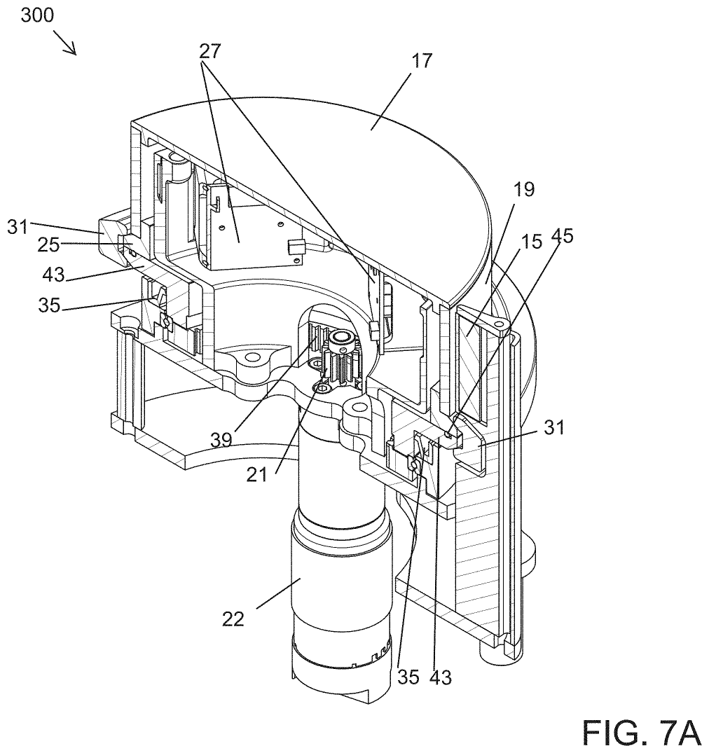

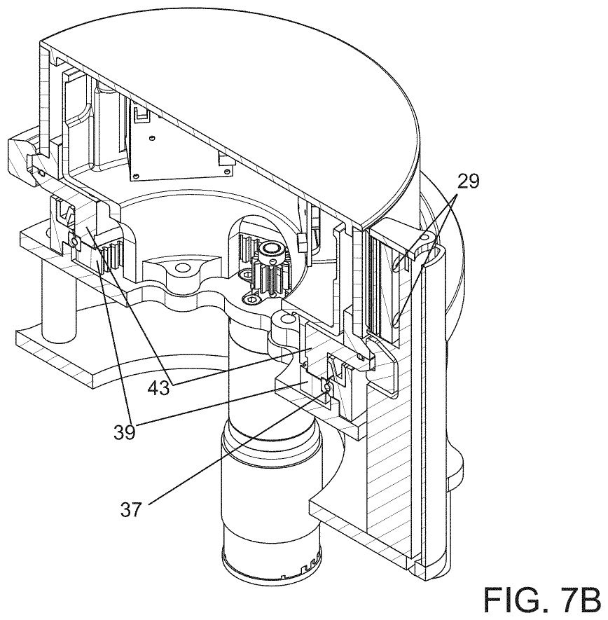

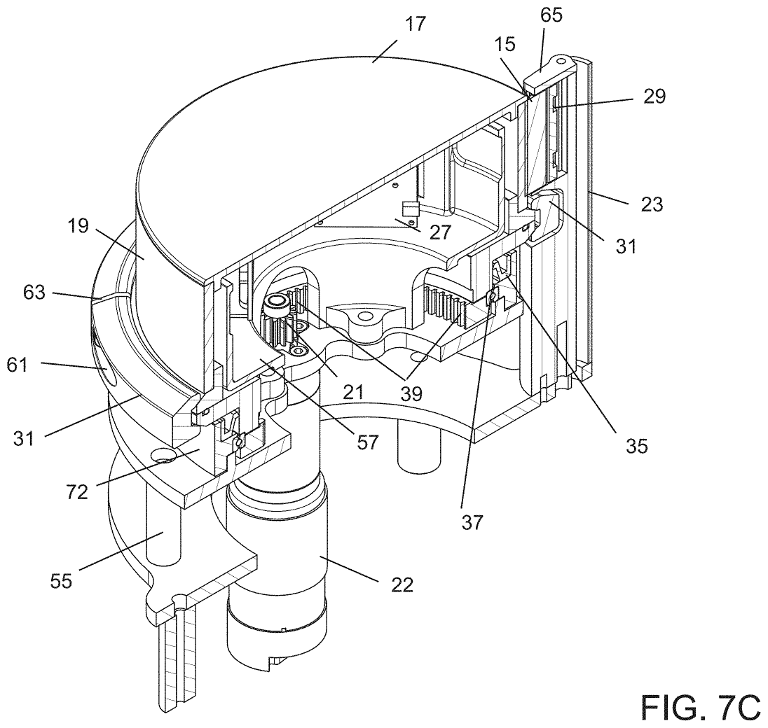

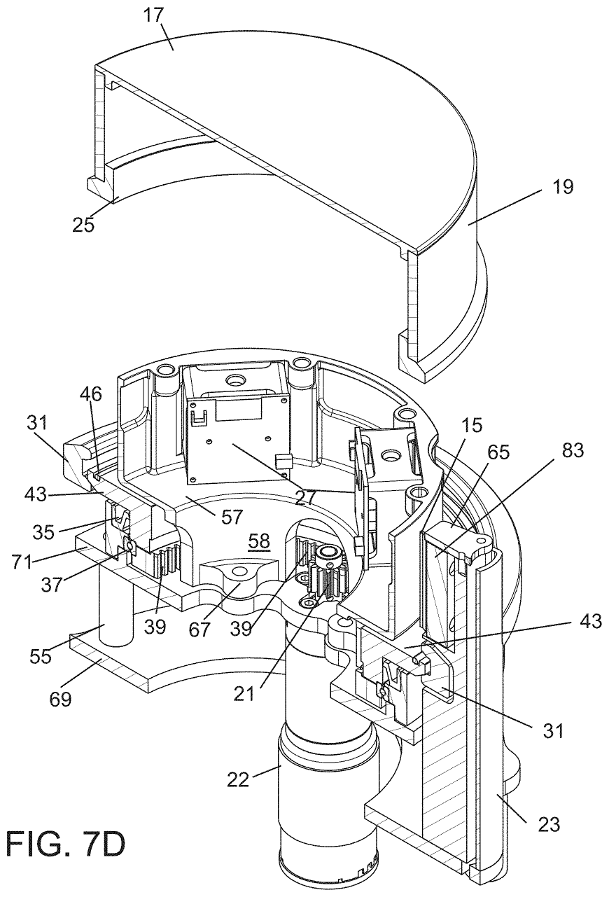

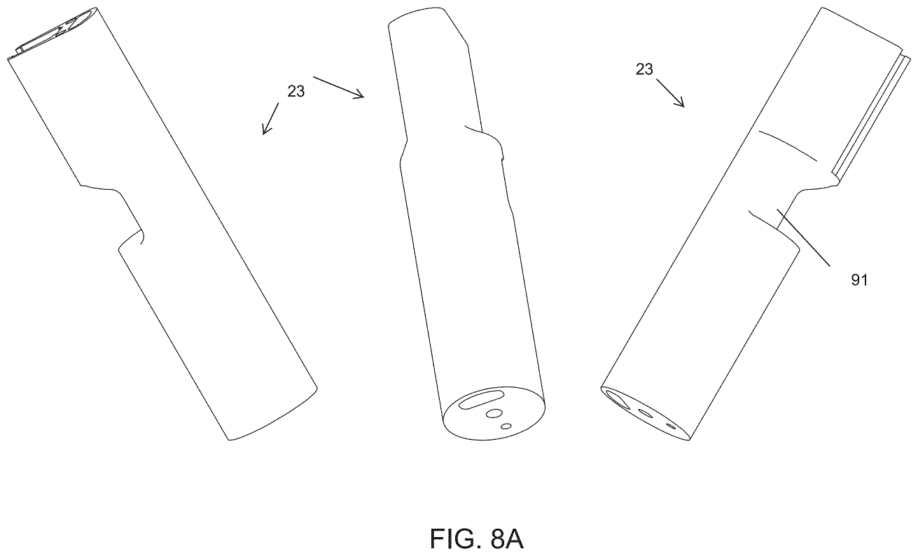

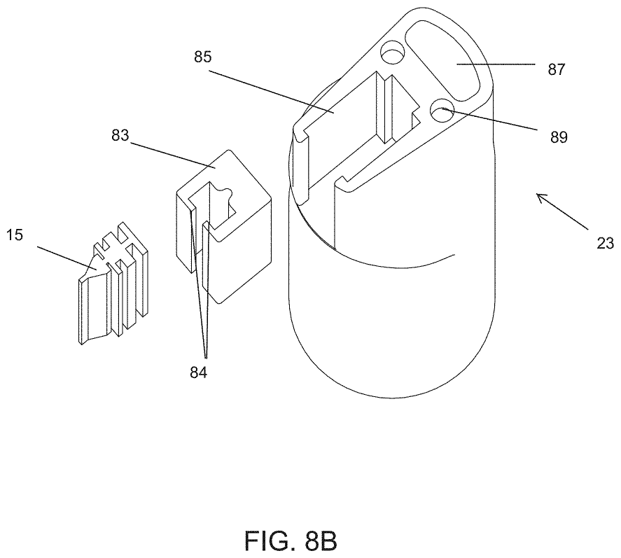

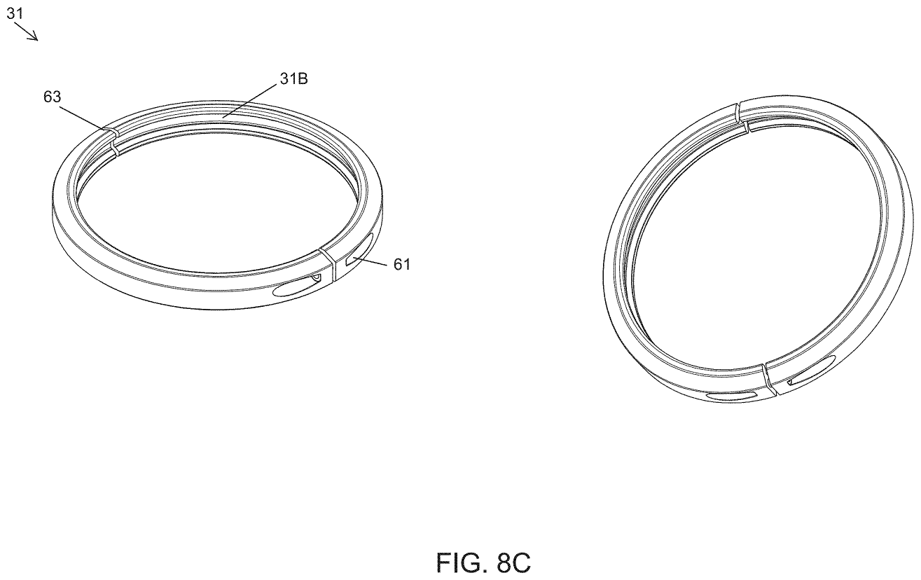

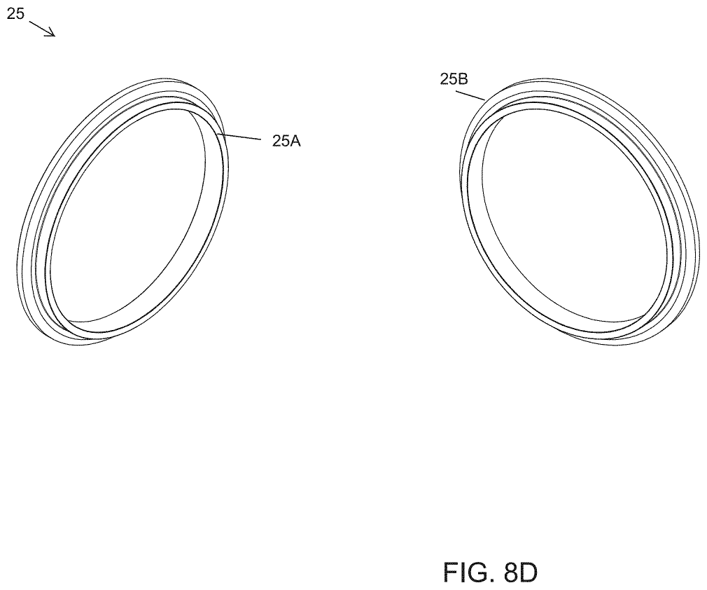

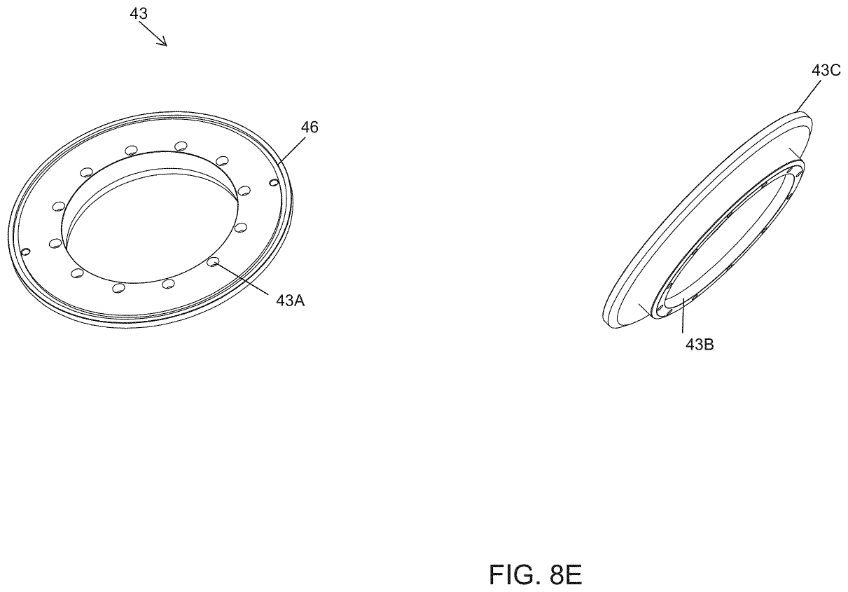

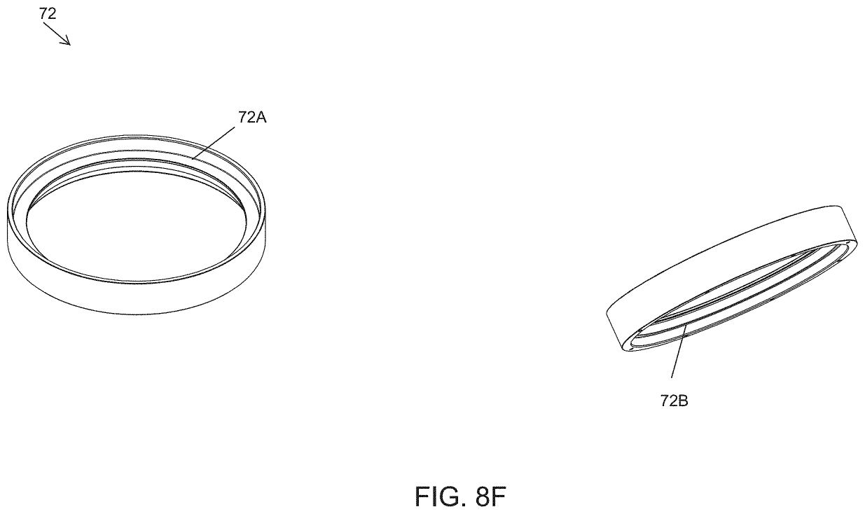

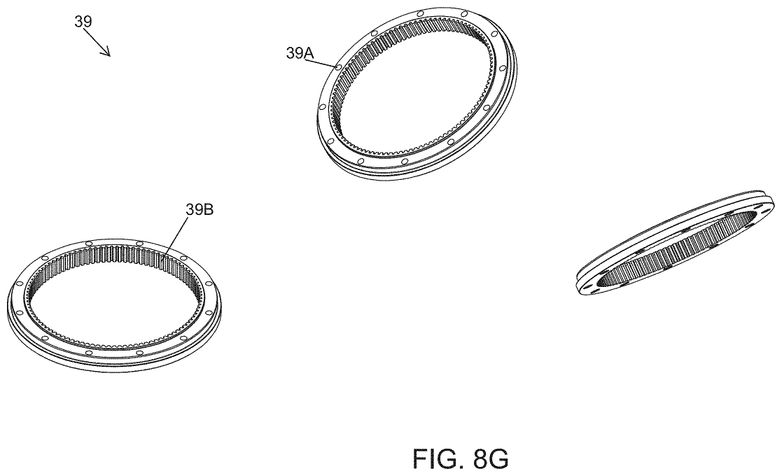

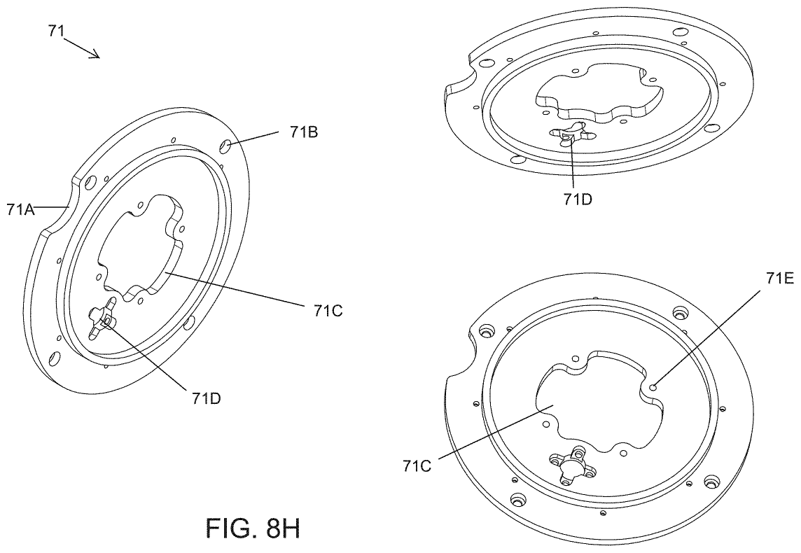

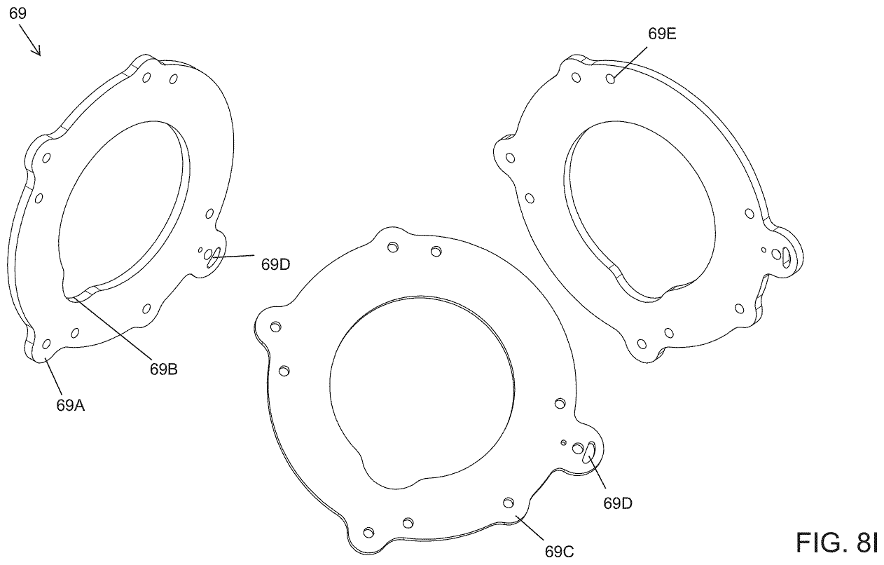

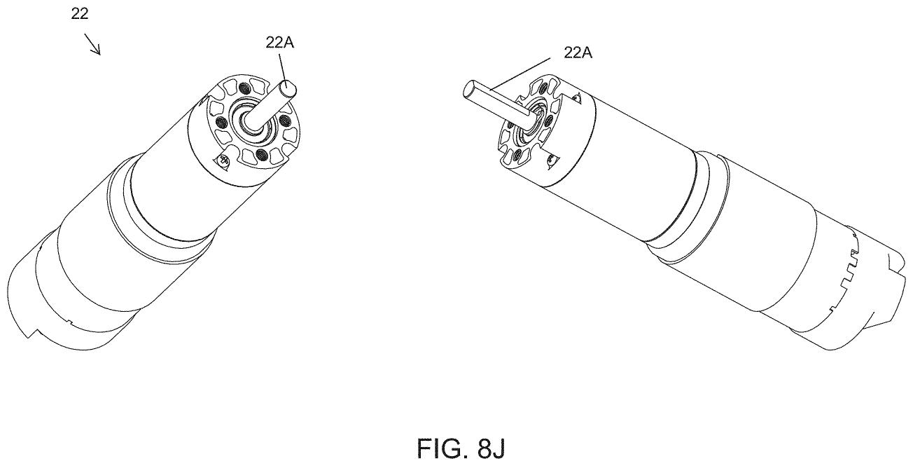

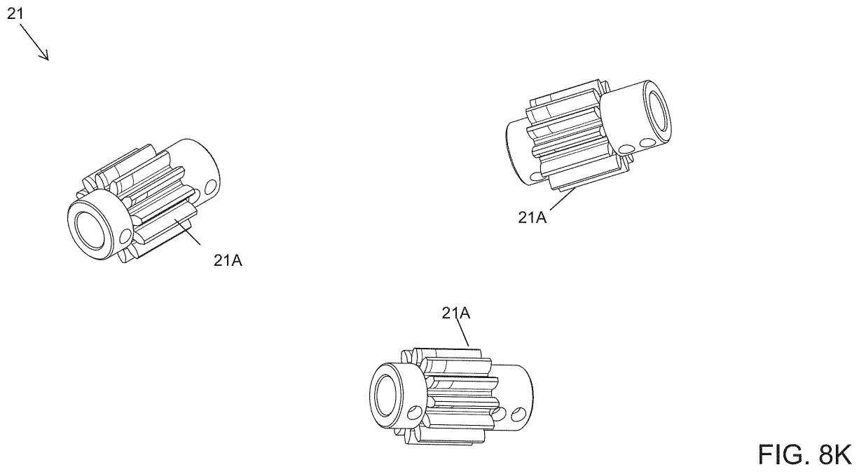

Referring now to FIGS. 7A-7D and 8A-8K, shield 19 can be constructed of any durable material that meets the desired sensor viewing requirements. For example, shield 19 (FIG. 5B) can include transparent glass, or polarized or otherwise treated material. Lid 17 (FIG. 5B) can be constructed of any material that meets weather and other sensor-related hazard protection requirements. For example, lid 17 (FIG. 5B) could include plexiglass or an opaque, to frequencies to which the sensors are not sensitive, material.

Continuing to refer to FIGS. 7A-7D and 8A-8K, clamp 31 secures the parts together that provide the interface between dome assembly 103 (FIG. 5C) and ring gear 39 (FIG. 6), thus enabling rotation of dome assembly 101 (FIG. 5B) based on the force provided by motor 22 (FIG. 5D) through gear 21 (FIG. 5D). Clamp 31 can include connection bands 63 (FIG. 8C), split v-band 31B (FIG. 8C), and fastener cavities 61 (FIG. 8C). Clamp 31 can include multiple sections that can be drawn to each other by fasteners inserted into fastener cavities 61 (FIG. 8C). Split v-band 31B (FIG. 8C) is sized to operably join the weather-sealable components of rotatable assembly 109 (FIG. 5C). Other geometries of band clamps are possible. Exemplary clamps can be found at https://www.aceraceparts.com/collections/v-bands?gclid=CjwKCAiArIH_BRB2EiwALfbH1FfSm434Efl6JhX0zhY0FgqXXbL3uEb93Cy0R g3hOqmHG-Lgn66YpBoCM_kQAvD_BwE.

Continuing to refer to FIGS. 7A-7D and 8A-8K, interface flange 25 provides the connection between dome assembly 101 (FIG. 5B) and operational assembly 105 (FIG. 5B). Interface flange 25 includes dome interface 25A (FIG. 8D) to which dome assembly 101 (FIG. 5B) is secured. Interface flange 25 includes clamp platform 25B (FIG. 8D) which rests flush against output flange 43 within split v-band 31B (FIG. 8C).

Continuing to refer to FIGS. 7A-7D and 8A-8K, output flange 43 provides the interface between interface flange 25 and operational parts of rotatable assembly 109 (FIG. 6). Output flange 43 includes clamp platform 43C (FIG. 8E) which rests flush against interface flange 25, and is drawn to seal with interface flange 25 by clamp 31. Output flange 43 includes o-ring cavity 46 that accommodates weather-sealing o-ring 45 (FIG. 6). O-ring 45 (FIG. 6) enables sealing against environmental contamination between output flange 43 and interface flange 25. In some configurations, o-ring 45 (FIG. 6) includes, but is not limited to including, a nitrile rubber o-ring, for example, a McMaster-Carr 9452K324 o-ring. Output flange 43 includes ring gear fastener cavities 43A (FIG. 8E). When aligned with ring gear 39 (FIG. 6), ring gear fastener cavities 43A (FIG. 8E) provide locations for fasteners to bond together ring gear 39 (FIG. 6), environmental seal 35 (FIG. 6), and thin section bearing 37 (FIG. 6), essentially the mechanism to seal the rotatable parts with the stationary parts.

Continuing to refer to FIGS. 7A-7D and 8A-8K, ring gear 39 enables movement of dome assembly 101 (FIG. 5C) through transmission of mechanical energy from motor gear 21 to ring gear 39. Ring gear 39 can include fastener cavities 39A (FIG. 8G) that enable fastening ring gear 39 to output flange 43, thus coupling movement-enabling ring gear 39 with dome assembly 101 (FIG. 5C). Ring gear 39 includes ring gear teeth 39B (FIG. 8G) having the same mesh as motor gear 21. Motor gear 21 is positioned to form a gear train with ring gear 39. Other mechanisms to enable rotation of rotatable assembly 109 (FIG. 6) are contemplated by the present teachings.

Continuing to refer to FIGS. 7A-7D and 8A-8K, in some configurations, stationary assembly 111 (FIG. 6) can include, but is not limited to including, environmental barrier assembly 104 (FIG. 5B), wiper assembly 105 (FIG. 5B), a means to move wiper assembly 105 (FIG. 5B), and sensors that are protected by rotating assembly 109 (FIG. 6). Stationary components include motor 22 (FIG. 7A), motor gear 21 (FIG. 7A), environmental shaft seal 35, thin section bearing 37, housing 72, sensor platform 71, and mounting platform 69. The combination of environmental shaft seal 35, thin section bearing 37, and housing 72 enable smooth rotational movement of rotating assembly 109 (FIG. 6).

Continuing to refer to FIGS. 7A-7D and 8A-8K, cross sections of exemplary system 300 can illustrate how an exemplary dome assembly might be configured to protect sensors and enable accurate and obstruction-free sensor data gathering. In the configuration shown, sensors 27 are part of a stationary sensor assembly that includes sensor shelf 57 (FIG. 7D) whose feet 67 (FIG. 7D) can be coupled with sensor platform 71 (FIG. 7D) at sensor mounting points 71E (FIG. 8H). Sensors 27 can include any type of sensor, for example, but not limited to, cameras. In some configurations, lighting can be included to illuminate an area observed by the sensors. In these configurations, the lights can be placed behind a shield that can be cleaned as described herein. In some configurations, the sensors and lights can be positioned behind the same shield. In some configurations, separate shields can be provided for the lights and the sensors. Sensors 27 can be positioned in any way that is suitable for the application. For autonomous driving, for example, a 360° view could necessitate multiple sensors positioned at various orientations. Exemplary system 300 can be sized—height, width, depth—to accommodate sensors 27, sensor shelf 57, and mounting wall 58. In some configurations, sensors 27 can detect obstructions and can automatically initiate the rotation of dome assembly 101 (FIG. 5C).

Continuing to refer to FIGS. 7A-7D and 8A-8K, sensor platform 71 includes cavity 71D (FIG. 8H) that is shaped to accept and guide motor gear 21 so that it is positioned to form a gear train with ring gear 39. Sensor platform 71 includes fastening features 71E (FIG. 8H) that align with the feet of sensor assembly 107 (FIG. 5C). The alignment enables fastening of sensor assembly 107 (FIG. 5C) to sensor platform 71. Cavity 71C (FIG. 8H) enables threading of data and power wiring to sensors 27. Sensor platform 71 includes cutout 71A (FIG. 8H) to give clearance for wiper blade holder 23. In some configurations, sensor shelf 57 is spaced from mounting platform 71 (FIG. 7D) to provide space for environmental barrier assembly 104 (FIG. 5B), for example. Mounting wall 58 (FIG. 7D) provides such spacing by connecting sensor feet 67 (FIG. 7D) with sensor shelf 57 (FIG. 7D). In some configurations, mounting wall 58 (FIG. 7D) may not be necessary. Sensor shelf 57 (FIG. 7D) could be connected directly with mounting platform 71 (FIG. 7D), or could be absent altogether.

Continuing to refer to FIGS. 7A-7D and 8A-8K, motor 22 (FIG. 8J) provides mechanical energy to gear 21 (FIG. 8K), and that energy is thus transferred to pinion ring gear 39 (FIG. 8G) through gear teeth 21A (FIG. 8K), and ultimately rotates dome assembly 101 (FIG. 5C). Motor 22 (FIG. 8J) includes stem 22A (FIG. 8J) that accepts motor gear 21 (FIG. 8K). Motor 22 (FIG. 8J) is be powered by any available source, including, but not limited to, direct current sources such as batteries or solar panels, or alternating current sources such as the power grid. In some configurations, motor 22 (FIG. 8J) includes an encoder to provide positional feedback, thus enabling partial rotation of shield 19.

Continuing to refer to FIGS. 7A-7D and 8A-8K, wiper cartridge holder 83 (FIG. 7D), wiper blade hinge(s) 29 (FIG. 7C) and wiper blade 15 (FIG. 7D) enable clearing of the rotating shield protecting the sensors. Wiper blade 15 (FIG. 7D) can take the form of replaceable cartridge that can fit into cartridge holder 83 (FIG. 7D). In some configurations, wiper cartridge holder 83 includes spring-like features 84 (FIG. 8B) that maintain positional restoration of wiper blade 15 while allowing flexibility. In some configurations, a separate spring is mounted between wiper blade holder 23 and wiper blade 15 to provide the compliance necessary to clean shield 19 of debris with substance. Wiper blade 15 can take any shape that conforms to the shape of shield 19 so that the wiping surface of wiper blade 15 can connect with the desired amount of the surface of shield 19. Some or all of the surface of shield 19 can be wiped by wiper blade 15. Wiper blade holder 23 includes cartridge cavity 85 (FIG. 8B), upper retainer cap fastener cavities 89 (FIG. 8B), and mounting cavity 87 (FIG. 8B). Wiper blade cavity 85 (FIG. 8B) can be sized to incorporate wiper cartridge holder 83. Wiper blade 15 and cartridge holder 83 (FIG. 8D) can be formed as a single unit or can be separate units. Further, wiper blade 15 and wiper blade holder 23 can be formed as a single unit, or can be separate units. Upper retainer cap 65 is mounted to wiper blade holder 23 such that it spans wiper cartridge holder 83 and positionally maintains wiper cartridge holder 83 while allowing access to wiper blade 15 to remove and replace it as necessary. Upper retainer cap 65 includes at least one upper retainer cap pin (not shown) that couples wiper blade holder 23 to upper retainer cap 65.

Continuing to refer to FIGS. 7A-7D and 8A-8K, wiper blade holder 23 includes cutout 91 (FIG. 8A) that provides the space required for clamp 31. Other geometries for wiper blade holder 23 are possible. For example, wiper blade holder 23 can be set far enough away from shield 19 to clear or partially clear clamp 31. In such configurations, cutout 91 (FIG. 8A) may not be needed or can take on the size necessary to accommodate clamp 31. Cartridge cavity 85 (FIG. 8B) holds wiper blade cartridge holder 83 (FIG. 8B), which is sized to, for example, slidably accept wiper blade 15 (FIG. 7B). In some configurations, wiper blade 15 (FIG. 7B) can be easily removed and replaced, and cartridge holder 83 (FIG. 7B) can vary in size to accept varying sizes of wiper blades 15 (FIG. 7B). Cartridge cavity 85 (FIG. 7B) can be sized to allow varying sizes of cartridge holders 83 (FIG. 7B). In some configurations, wiper blade 15 (FIG. 7B) and wiper blade cartridge 83 (FIG. 7B) can be formed into a single component, making the entire component removable and replaceable. Such a single unit cartridge/blade includes springs to maintain its positional placement against the rotating shield, or springs can be separately mounted. The cartridge and/or the entire wiper blade holder includes swing mechanism(s) to displace either or both of them when parts of the rotating assembly such as, for example, but not limited to, shield 19 and clamp 31 must be removed, replaced, and/or cleaned. Wiper blade 15 (FIG. 7B) can be constructed of any durable material that can be formed into a non-abrasive, compliant blade shape.

Continuing to refer to FIGS. 7A-7D and 8A-8K, in some configurations, environmental barrier assembly 104 (FIG. 5B) retains rotation support assembly 103 (FIG. 5B) to mounting platform 71 (FIG. 5D), while allowing it to rotate. Environmental barrier assembly 104 (FIG. 5B) can, among other things, provide a bearing surface to guide the rotation of rotating assembly 109 (FIG. 6), provide a reaction force to the pinon gear (ring gear 39 (FIG. 5D)), and provide a barrier against environmental contaminants. In some configurations, environmental barrier assembly 104 (FIG. 5B) can include, but is not limited to including, thin section bearing 37 (FIG. 7B) that can be chosen, in some configurations, to minimize its footprint within the assembly, and includes ball bearings to minimize friction, and thus reduce power requirements and extend the range of the assembly, if battery operated, for example. Thin section bearing 37 (FIG. 7B) can include, but is not limited to including, a Kaydon JA050XP0 ball bearing having sealed single-row construction. Other types of bearings can be used that include characteristics such as having small ball bearings to minimize friction and required motor power, and thus extend power range. In some configurations, environmental barrier assembly 104 (FIG. 5B) can include, but is not limited to including, environmental shaft seal 35 (FIG. 7C) that retains the bearing lubricant for thin section bearing 37 (FIG. 7B) to avoid leakage that may cause environmental issues, and to minimize unwanted substance ingress. Environmental shaft seal 35 (FIG. 7C) provides sealing between output flange 43 (FIG. 7B) and thin section bearing 37 (FIG. 7B). In some configurations, seal 35 (FIG. 7C) can include a Motion Industries CR 52330 seal made of nitrile rubber. Other types of seals are possible that are designed for a rotating shaft, are compliant, include a lip seal design that can accommodate eccentricities and changes in surface structure, and are less stiff than an o-ring. Housing 72 (FIG. 8F) couples environmental barrier assembly 104 (FIG. 5B) with rotational assembly 109 (FIG. 6) to enable secure environmental sealing between rotational and stationary parts of the system, as well as fluid movement of rotational assembly 109 (FIG. 6). Housing 72 (FIG. 8F) is coupled with platform 71 (FIG. 7D), the combination of which is assembled around thin section bearing 37 (FIG. 7B) that is clamped into place by the combination of housing 72 (FIG. 8F) and platform 71 (FIG. 7D). In some configurations, stationary platform 69 (FIG. 7D) can provide a surface for mounting spacers 55 (FIG. 7D) and wiper blade holder 23 (FIG. 7A). In some configurations, spacers 55 (FIG. 7D) might be necessary between mounting platform 71 (FIG. 7D) and base platform 69 (FIG. 7D). Stationary platform 69 includes wiper blade holder fastener cavity 69D (FIG. 8I) that accommodate attaching wiper blade holder 23 to a non-rotating surface. Stationary platform 69 (FIG. 7D) includes fastening cavities 69E (FIG. 8I) and geometric features 69A (FIG. 8I) to accommodate mounting other non-rotating components. Stationary platform 69 (FIG. 7D) includes cutout 69B (FIG. 8I) that accommodates wiring, sensor structure, and motor 22 (FIG. 7A)/motor gear 21 (FIG. 7A) on its way to cavity 71D (FIG. 8H).

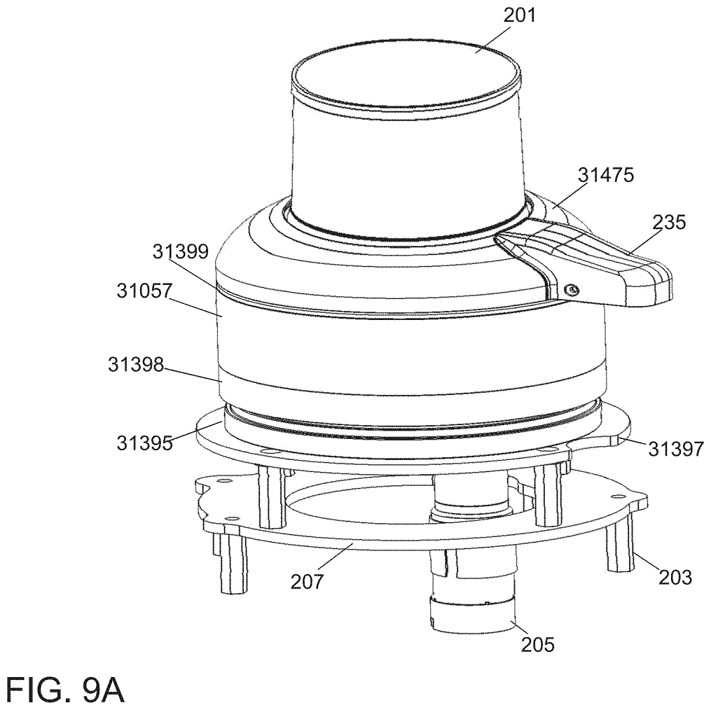

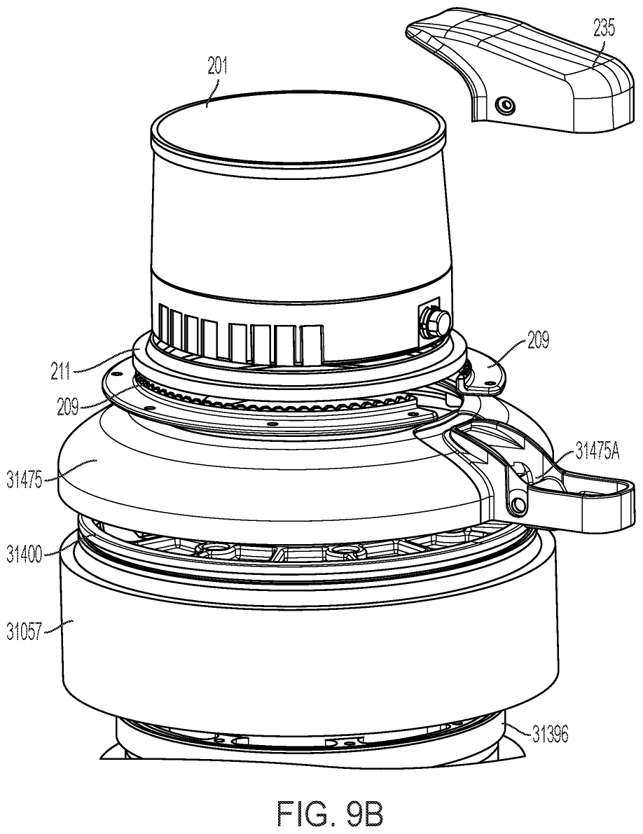

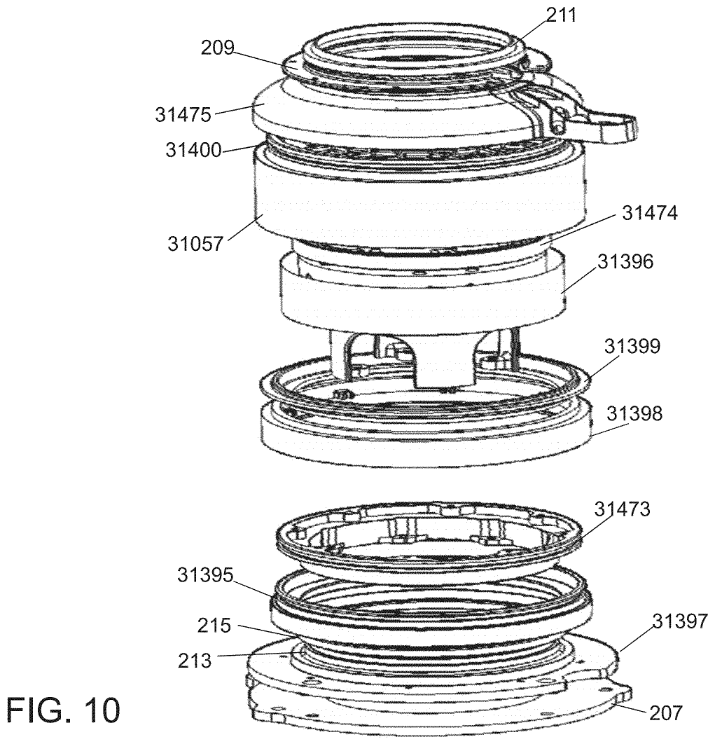

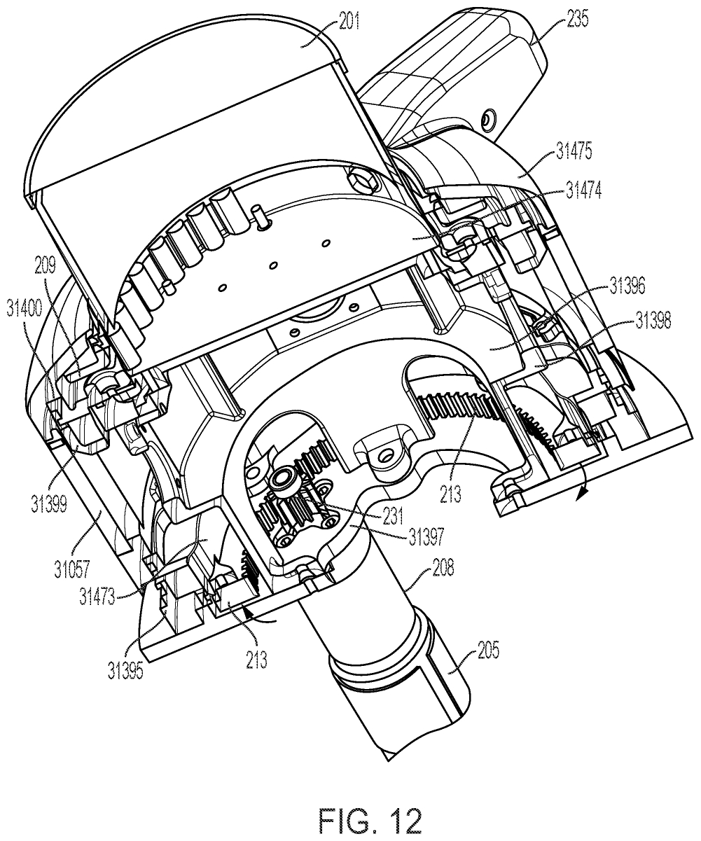

Referring now to FIGS. 9A-9B, and 10-12, another configuration of the present teachings includes at least one sensor vision clearing device. The device includes a rotating shield, stationary parts, including the sensors and a motor, and an interface between the rotating and stationery parts. The rotating parts include sensor shield 31057 that rotates past a wiper blade (described elsewhere herein). In some configurations, flange 31398 and cap 31399 are operably coupled to sensor shield 31057. Cap 31399 presses against flexible seal 31473 that will provide an interface between rotating and stationery parts. An o-ring between flange 31398 and flexible seal 31473 prevents environmental contaminants such as fluid from entering the sealed area where the sensors are located. Together, sensor shield 31057 (FIG. 12), cap 31399 (FIG. 12), flange 31398 (FIG. 12), flexible seal 31473 (FIG. 12), ring gear 213/bearing 215 (FIG. 10), and the o-ring rotate as the wiper blade clears sensor shield 31057. Motor 208 (FIG. 12), driven by motor assembly 205 (FIG. 12), both of which are stationary, rotate pinion gear 231 (FIG. 12), which rotates about the axis of motor 208 (FIG. 12). Pinion gear 231 (FIG. 12), which engages with ring gear 213 (FIG. 12), causes the rotation of the rotatable elements.

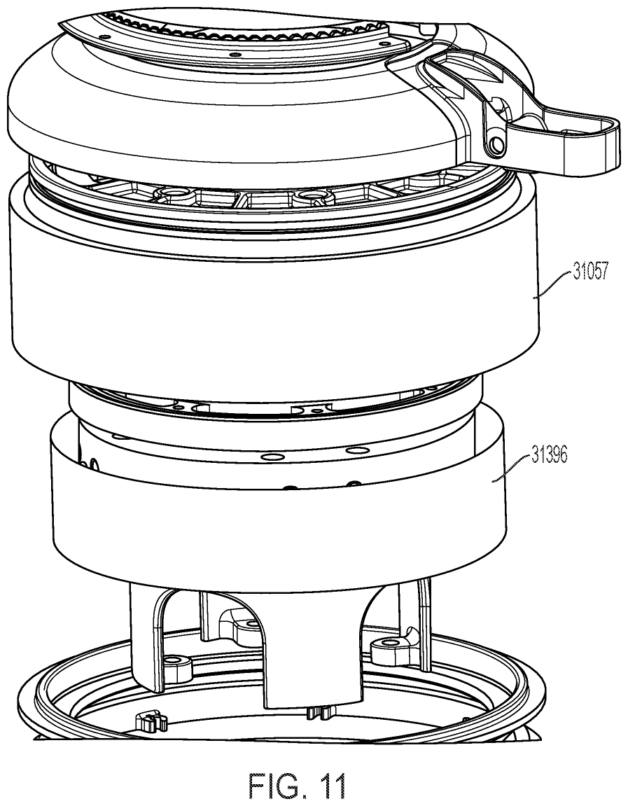

Continuing to refer to FIGS. 9A-9B, and 10-12, the stationary parts include the sensors themselves, the motor, and mounting parts. In some configurations, the sensors (not shown) can include cameras, LIDAR, and other types of sensors in which a clear view is required to collect usable data. In some configurations, a sensor mounting system such as mount 31396 (FIG. 12) can be used to hold the sensors. Sensor mount 31396 (FIG. 12) mounts to, in the exemplary configuration, LIDAR mount 31474 (FIG. 12). Other stationary parts include cap 31475 (FIG. 12), housing 31395 (FIG. 10), LIDAR cover 31400 (FIG. 10), and rod 211/seal clamp 209 (FIG. 9B) that cover LIDAR 201 (FIG. 9B) and seal it from environmental contamination, respectively. In the configuration shown, LIDAR 201 is protected from the elements by sensor cap 31475 (FIG. 12) which also includes cord routing area 31475A (FIG. 11A). Other devices can be accommodated, and other geometries to accommodate various sensors are contemplated by the present teachings. Power and/or data wires that provide power to LIDAR 201 and receive data from LIDAR 201 are routed to/from LIDAR 201 through routing area 31475A. Routing area 31575A is further protected from the elements by cord cover 235. Cord cover 235 can be fixedly attached to sensor cap 31475, or can be rotatably coupled with sensor cap 31475. When cord cover 235 is rotatably coupled, cord cover 235 can be lifted to expose the routed cables. Otherwise, cord cover 235 can be disengaged from sensor cap 31475 to expose the routed cables. Stationary parts upper motor carrier 31397 and lower motor carrier 207 stabilize motor assembly 205 as motor 208 rotates the sensor shield 31057 and other rotatable components. The geometry of the shown configuration requires spacers 203 (FIG. 9A), which can be added or subtracted as necessary.

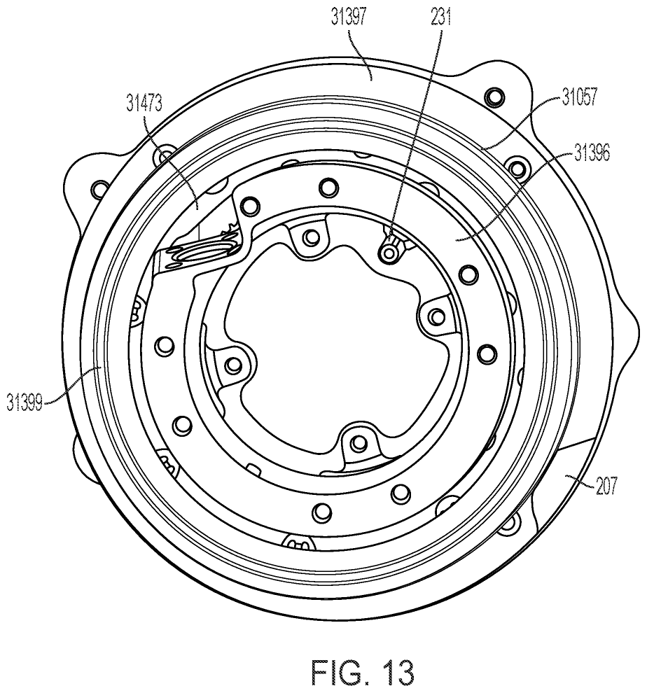

Referring now to FIG. 13, a top-down view of the second configuration of the present teachings is shown. Planetary pinion 231 which is driven by motor 208 (FIG. 12) and engages with ring gear 213 (FIG. 12) to rotate sensor shield 31057 (FIG. 12) to clear the path before the sensors mounted by sensor mount 31396. Shield cap 31399 seals rotating sensor shield 31057 from environmental contaminants that could enter the space between the glass and the sensors, and therefore rotates. Likewise, flexible seal 31473 rotates.

Configurations of the present teachings can be directed to computer systems for accomplishing the methods discussed in the description herein, for example to control rotation duration and possibly speed depending upon the presence of debris on shield 19, and to computer readable media containing programs for accomplishing these methods. The raw data and results can be stored for future retrieval and processing, printed, displayed, transferred to another computer, and/or transferred elsewhere. Communications links, where desired, can be wired or wireless, for example, using cellular communication systems, military communications systems, and satellite communications systems. Parts of the system can operate on a computer having a variable number of CPUs. Other alternative computer platforms can be used.

The present configuration can include software for accomplishing the methods discussed herein, and computer readable media storing software for accomplishing these methods. The various modules described herein can be accomplished on the same CPU, or can be accomplished on different computers. In compliance with the statute, the present configuration has been described in language more or less specific as to structural and methodical features. It is to be understood, however, that the present configuration is not limited to the specific features shown and described, since the means herein disclosed comprise preferred forms of putting the present configuration into effect.

While the present teachings have been described above in terms of specific configurations, it is to be understood that they are not limited to these disclosed configurations. Many modifications and other configurations will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for maintaining an unobstructed pathway, the unobstructed pathway enabling at least one sensor to capture sensor data, the system comprising:
at least one movable component protecting the at least one sensor; and
at least one stationary component including at least one at least one wiper blade assembly, the at least one sensor, at least one mounting surface for the at least one sensor, and a means to move the at least one moveable component,
wherein the at least one stationary component wipes the at least one movable component as the at least one movable component moves past the at least one wiper blade.

2. The system as in claim 1 wherein the at least one wiper blade assembly comprises:
at least one wiper blade holder integrated with at least one wiper blade.

3. The system as in claim 1 wherein the at least one wiper blade assembly comprises:
at least one wiper blade holder including at least one wiper blade cartridge cavity; and
at least one wiper blade cartridge removably positioned within the at least one wiper blade cartridge cavity.

4. The system as in claim 1 wherein the at least one wiper blade assembly comprises:
at least one wiper blade; and
at least one spring operably coupled with the at least one wiper blade, the at least one spring enabling compliant motion of the at least one wiper blade with respect to the at least one moveable component.

5. The system as in claim 1 wherein the at least one movement component comprises:
at least one motor gear.

6. The system as in claim 1 wherein the at least one stationary component comprises:
at least one movement component moving the at least one movable component; and
at least one barrier between the at least one sensor and an environment surrounding the at least one sensor.

7. The system as in claim 6 wherein the at least one barrier comprises:
at least one an environmental seal;
at least one housing;
at least one platform; and
at least one platform clamp clamping the at least one platform and the at least one housing around the at least one environmental seal,
wherein the clamping preventing environmental contaminants from entering an interior of the at least one movement component and the at least one stationary component.

8. The system as in claim 7 wherein the at least one platform clamp comprises;
at least one v-clamp.

9. The system as in claim 6 wherein the at least one movable component comprises:
at least one shield situated in a field of view of the at least one sensor; and
at least one movement component interface operably coupled with the at least one movement component, the at least one movement component and the at least one movement component interface enabling movement of the at least one moveable component.

10. The system as in claim 9 wherein the at least one shield comprises:
at least one dome surrounding the at least one sensor.

11. The system as in claim 10 wherein the at least one dome comprises:
a circular shape.

12. The system as in claim 9 wherein the at least one movement component interface comprises:
a ring gear.

13. A system for clearing at least one shield, the at least one shield configured to enable at least one sensor to capture sensor data, the system comprising:
a first assembly including the at least one sensor and at least one wiper blade; and
a second assembly configured to move with respect to the first assembly, the second assembly including the at least one shield, the at least one shield interfacing with the at least one wiper blade, the at least one wiper blade configured to wipe the at least one shield.

14. The system as in claim 13 wherein the first assembly comprises:
a motor assembly configured to move the second assembly.

15. The system as in claim 14 wherein the first assembly comprises:
a motor carrier configured to stabilize the motor assembly.

16. The system as in claim 14 wherein the motor assembly comprises:
a motor; and
a pinion gear driven by the motor.

17. The system as in claim 13 wherein the first assembly comprises:
a sensor mounting platform configured to mount the at least one sensor in the first assembly; and
a shield housing configured to enable an interface between the first assembly and the second assembly.

18. The system as in claim 13 wherein the second assembly comprises:
a shield cap;
a shield cap interface configured to press against the shield cap to enable sealing against environmental contaminants;
a first assembly interface hub; and
a flange configured to operably couple the shield with a first assembly interface hub.

19. The system as in claim 16 wherein the second assembly comprises:
a ring gear configured to be driven by the pinion gear, the ring gear enabling movement of the second assembly with respect to the first assembly.

20. The system as in claim 13 further comprising:
a cable run configured to provide a conduit for data and power cables to devices in the system.
